(19) United States
(12) Patent Application Publication
(10) Pub. No.: US 2006/0174327 A1
(43) Pub. Date: Aug. 3, 2006

(54) Apparatus and method for a personal cookie repository service for cookie management among multiple devices

(76) Inventors: Yu Song, San Jose, CA (US); Hao-hua Chu, Mountain View, CA (US); Masaji Katagiri, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/387,679

(22) Filed: Mar. 22, 2006

Related U.S. Application Data
(62) Division of application No. 10/235,350, filed on Sep. 5, 2002.

(51) Int. Cl. H04L 9/32

(52) U.S. Cl. 726/3

(57) ABSTRACT

A data processing method includes, at a client device, retrieving client state information from a remote location associated with the client device and using the client state information for access of network locations. The data processing method further includes storing updated client state information at the remote location upon completion of the access of the network locations. The remote location forms a personal cookie repository where cookies may stored for subsequent use by any device of a user.

### BACKGROUND

The present invention relates generally to communication of user information between remote and local data sources. More particularly, the present invention relates to apparatus and method for a personal cookie repository service for cookie management among multiple devices.

In the context of Internet communication, the term cookie is used to refer to the state information that passes between an origin server and user agent and that gets stored by the user agent. A cookie is information that an Internet web site stores on a computing device so that it can remember something about the computing device or its user at a later time. The computing device may be any device with communication and processing capability for accessing the internet, by wireline or wireless connection. An application program called a browser operates on the computing device to provide standard user interface and access to Internet sites of the World Wide Web (“Web”).

A cookie is set by the web site and usually contains the browser's session state and personal information about the user. Alternatively, a cookie is described as information for future use that is stored by a server on the client side of a http://searchnetworking.techtarget.com/sDefinition/0,sid7_gci211796,00.htmlclie nt/server communication. In one example, a cookie records the user's preferences when using a particular web site. Using the World Wide Web's Hypertext Transfer Protocol (HTTP), each request for a web page is independent of all other requests. For this reason, the web page server has no memory of what pages it has sent to a user previously or anything about previous visits by the user or the computing device. A cookie is a mechanism that allows the server to store information about a user on the user's own computer.

In general, the cookie mechanism involves encapsulating cookies in the header of an HTTP response message sent to a client browser in response to a browser selection (“click”) at the web site. After the client browser receives the HTTP response message, it extracts cookies out of the HTTP message header and stores them into its local storage. At a later time, when the client browser makes a request to the same website, the browser attaches the cookies set by the same website in its HTTP request header.

The location of the cookies stored on a client depends on the browser operating on the client computing device. In one example, the browser Internet Explorer®, by Microsoft Corporation, stores each cookie as a separate file under a Windows subdirectory. The Netscape Navigator® browser stores all cookies in a single cookies.txt file. The cookies that are stored on a computing device are referred to collectively as the cookie state of the device.

Since cookies are stored on the local computing device that receives them, cookies are said to be tied to a specific browser on a specific device rather than to a specific user. For a user who may use multiple computing devices to access the same web sites, the same web sites may set different cookies on different devices as the user switches among devices. This may create inconsistent cookie states on different devices for the same user.

Given different cookie states, web sites that rely on cookies to track the state of a user or to maintain user preferences may view the same user differently depending on which device the user is using. This is undesirable for both the user and websites. As more devices become web-enabled, the likelihood of inconsistent cookie states increases. For example, one user may use an office computer to access one or more web sites, subsequently use a laptop computer with wireless communication capability to access some of the same web sites, use a web-enabled cellular telephone to access some of these web sites and use a home computer to access still others of these web sites. Each device, the office computer, the laptop computer, the cellular telephone and the home computer, stores cookies tied to the browser on the specific device. The cookies may not be identical so the cookie states are inconsistent. When the user switches among these devices or re-accesses a web site from yet another browser, the results may be inconsistent or unexpected because of the mismatch in the cookie state.

Accordingly, there is a need for an improved method for managing cookies among multiple devices of a user.

### BRIEF SUMMARY

By way of introduction only, a personal cookie repository (PCR) service is introduced that maintains up-to-date cookies for the user regardless of which device the user uses to access websites. The PCR service also eliminates the need to transfer cookie state between browsers. The PCR service automatically synchronizes the state of cookies between any user device and the cookie repository server.

The foregoing summary has been provided only by way of introduction. Nothing in this section should be taken as a limitation on the following claims, which define the scope of the invention.

### BRIEF DESCRIPTION OF THE DRAWINGS

FIG. 1 is a block diagram illustrating operation of a personal cookie repository service;

FIG. 2 illustrates a personal cookie repository login window;

FIG. 3 illustrates one embodiment of cookie storage in a personal cookie repository server;

FIG. 4 is a block diagram illustrating operation of a personal cookie repository service;

FIG. 5 illustrates an alternative embodiment of cookie storage in a personal cookie repository server;

FIG. 6 is a block diagram illustrating operation of a personal cookie repository service; and

FIG. 7 is a block diagram illustrating operation of a cookie proxy system.

### DETAILED DESCRIPTION OF THE PRESENTLY PREFERRED EMBODIMENTS

A variety of embodiments of the present invention are disclosed below. In accordance with one embodiment disclosed herein, a data processing method includes retrieving client state information from a remote location to a client device and using the client state information to access of network locations. The client state information may include data files known as cookies. The remote location may be referred to as a cookie repository. The client state information may include other data and instructions in one or more files or data structures accumulated during the access of network locations. This access in one form is accomplished by browsing the internet including the World Wide Web (“Web”). The data processing method of this embodiment further includes storing updated client state information at the remote location upon completion of the access of the network locations. After browsing is complete, the updated cookies are stored in the cookie repository.

Another embodiment provides a personal cookie repository method. The method includes retrieving stored cookies from a remote personal cookie repository service and subsequently accessing network locations such as Web sites of the internet. Location-related cookies retrieved from the personal cookie repository are exchanged with updated location related cookies at the network locations. Finally, cookies including the stored cookies are stored at the personal cookie repository service.

Another embodiment is provided as computer readable computer code stored on a computer readable storage medium. The computer readable code includes several portions of code, including first code configured to initiate a cookie access operation to a remote personal cookie repository service. The code further includes second code to receive cookies from the repository service. Third code is configured to interact with a browser program to provide user cookies for accessed network locations. Fourth code initiates a user cookie storage operation for storage of the user's cookies.

Another embodiment is configured as a browser plug in. A browser plug-in is code or data which operates in conjunction with a browser application to provide additional functionality not possessed by the browser operating alone. Icon code displays an icon on a browser screen. Login screen code displays a login screen. Access code accesses cookies over a network at a personal cookie repository network location.

Another apparatus provides a personal cookie repository system. This system includes storage means for storing user cookies. A storage processor receives cookies for storage from users. A request processor is configured to provide cookies to users in response to cookie retrieval request from a user.

In another embodiment, a personal cookie repository method includes receiving a login request from a remote user. In response to the login required cookies are provided. Subsequently, updated cookies are received at the service from the user and stored future user access.

In another embodiment, a cookie proxy method includes receiving at a cookie proxy a request for access to a web site. In response to the request, the method includes retrieving from storage cookies associated with the user and associated with the web site. The method further includes forming a new request using the retrieved cookies and the received request and communicating the new request to the web site.

In yet another embodiment, a method of preserving cookies among multiple devices is provided. The method includes capturing cookies on a current device, storing the captured cookies on a central storage and retrieving the stored cookies from the central storage for subsequent use.

Still further, another embodiment provides a method for preservation of cookies among multiple devices. The method includes retrieving cookies from central storage for a first browser and establishing an active session with a web site using the first browser. The method further includes ending the active session, updating cookies at the central storage, the retrieving cookies from the central storage and reestablishing an active session using a second browser. Details of these and other embodiments will be provided below.

Referring now to the drawing, FIG. 1 is a block diagram illustrating operation of a personal cookie repository service. In accordance with the illustrated disclosed cookie repository service, the association between cookies and a user's browser/device is decoupled. Instead, a new association between cookies and a user is established. This new association enables a user to have the most updated cookies no matter which browser/device she is using and to provide a centralized a cookies repository and a consistent cookie management interface.

In FIG. 1, a user 102 uses two client devices 104, 106 at different times to access one ore more web sites such as web site 112. Each device 104, 106 device may be any device with communication and processing capability for accessing the internet, by wireline or wireless connection. Examples of such devices includes desk top or laptop computers, personal digital assistants (PDAs), cellular and personal communication system (PCS) telephones, pagers and any other type of computing and communication device. Each device includes generally a processor, memory and user interface devices such as a keypad, key board, display, microphone and speaker. An application program called a browser operates on each computing device to provide standard user interface and access to Internet sites of the World Wide Web (“Web”). Thus, the device 104 has a browser 108 and the device 106 has a browser 110. Each browser is an application program that controls access to the Web by the respective device and provides a user interface for the user 102 to control the browser. Examples of browsers are Internet Explorer and Netscape Navigator.

In general, a browser 108, 110 is controlled by the user 102 to request a page from the Web. Information about the website is displayed on a browser screen of the computing device. A request is encoded using HTTP and communicated to a remote location such as a server containing the web site 112. In response to the request, the server containing the web site 112 sends a response message to the requesting device. Reliable delivery of the request and the response are ensured using addressing and a communication standard such as Transaction Control Protocol/Internet Protocol (TCP/IP). Typically, one or more cookies encoded in a header of the response message. The browser 108, 110 of the requesting device 104, 106 stores the cookies in storage media of the computing device 104, 106. When transmitting subsequent requests to the website 112, the browser 108, 110 sends the cookies to the web site for use by the web site. In this manner, the web site 112 has an accurate view of the current cookie state of the user 102 for each received request.

In accordance with one embodiment, the devices 104, 106 operate in conjunction with a server 118 to implement a personal cookie repository method. The method in this embodiment includes retrieving stored cookies from a remote personal cookie repository service at the server 118, downloading the cookies to one of the devices 104, 106. The device is then used by its user to access network locations, or visit web sites. When the user clicks on a graphical or textual link or otherwise designates a target network for access, the cookies associated with that target network location are retrieved from the server 118. After receiving new or updated cookies from the target network location, the updated cookies are then stored at the server 118.

In one embodiment of the personal cookie repository method, all cookies associated with the user or the device and stored at the server 118 are retrieved upon initial access to the server 118. The retrieved cookies are stored at the device. When the user selects a web site to visit, stored cookies at the device are used to form the request message sent to the web site. In another embodiment, operation of the browser is automatically monitored to determine where the user navigates the browser, or to identify the target network locations. Once the target network location is determined, a cookie request is sent to the server 118 to retrieve the user cookies associated with the target network location. This second embodiment may slow browser performance because of all the required cookie request communications and responses. However, this second embodiment reduces the storage requirements for cookies at the computing device. In accordance with the illustrated embodiment, each browser 108, 110 or each computing device 104, 106 further includes a personal cookie repository (PCR) plug-in. In FIG. 1, computing device 104 has a browser 108 with plug-in 114, and computing device 106 has a browser 110 with plug-in 116. A plug-in is a portion of computer readable program code which provides added functionality to a preexisting application, such as the browser 108, 110. A plug-in may be accessed, obtained and stored separately and independently from the browser. The plug-in may be customized upon installation to provide particular or optimal performance features in conjunction with the browser. Thus, the plug-in 114 may be separately installed with its associated browser 108 or the plug-in 114 may be inherently a part of the associated browser 108. In some embodiments, after installation, a plug-in displays an icon on the browser screen. By clicking or otherwise actuating the icon, the plug-in associated with the icon may be activated.

A PCR plug-in includes several portions of computer readable program code. In one embodiment, these include icon code for displaying an icon on a browser screen of a computing device and login screen code for displaying a login screen on the browser and receiving login information from a user of the computing device. The plug-in further includes access code for accessing cookies associated with the user over a network at a personal cookie repository network location, as will be discussed in greater detail below. In some embodiments, the PCR plug-in may be configured to monitor target network locations selected by the browser for network access. Before the request is sent by the browser, the PCR plug-in sends a cookie request to access cookies associated with the target network location. In this embodiment, the PCR plug-in further includes navigation monitoring code which monitors the navigation of the browser. When the browser selects a target network location, the navigation monitoring code detects the target network location selected by the browser and cooperates with the access code for accessing cookies associated with the target network location.

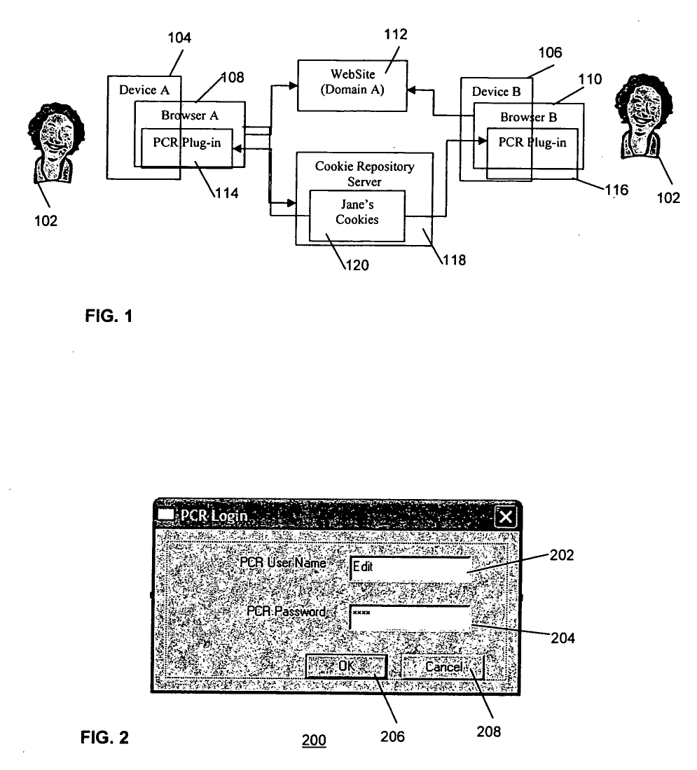

One example of a login screen is the PCR login window 200 shown in FIG. 2. The PCR login window is displayed by the login screen code of a PCR plug-in and includes a user name data entry window 202, a password data entry window 204 and an actuation button 206. A login cancel button 208 is also provided. In response to a user clicking on the actuation button 206, the PCR plug-in retrieves stored cookies associated with the user at the personal cookie repository network location. In one embodiment, a cookie retrieval request is prepared and transmitted to the personal cookie repository network location. The request includes data corresponding to the user's name, login identifier or other unique identification information entered in the user name data entry window 202, as well as data corresponding to the password entered in the password data entry window 204. The password and the login identifier or user name form login information for the user. The request includes code to cause equipment at the personal cookie repository network location to retrieve previously-stored cookies associated with the user and transmit the cookies to the computing device. Thus, the PCR plug-in further includes download code for retrieving the stored cookies. The PCR plug-in further includes upload code. Upon completion of a browsing session, the upload code stores cookies received during network access with the browser. The cookies are preferably stored in association with identification for the user at the personal cookie repository network location.

In some embodiments, security may be established to ensure that communication between the computing device and the personal cookie repository network location is kept private. For example, the personal cookie repository network location may require authenticated login access. In this case, the PCR plug-in may includes authentication code for initiating authenticated login access to the personal cookie repository network location in response to login information received from the user.

Returning again to FIG. 1, the illustrated embodiment further includes the cookie repository server 118, which forms the personal cookie repository network location. The server 118 operates as a personal cookie repository. The server may be any suitable device, such as a computer generally referred to as a server and having data processing and data communication capability. Access to the server may be in any convenient format or combination of formats, including wireless and wireline formats. Preferably, TCP/IP or a similar communication standard is used for communicating data with the server 118. In other applications, the server 1118 may be a networked data base or may be a distributed resource, with operational aspects of data storage and data management spread over a large number of devices at a variety of locations. In the illustrated embodiment, the cookie repository server is implemented as a server accessed by one or more clients such as the computing devices 104, 106 over the internet using HTTP and TCP/IP.

Stored at the server 118 are personal cookies of users such as the user 102. Preferably the personal cookies are stored at a particular location 120 in association with the identification information of the user so that the user's cookies can be reliably received. A database storing the cookies may be organized and accessed in any suitable way.

The server 118 implements a personal cookie repository system. The system includes a storage means for storing user cookies according to a user identification associated with the cookies. The system further includes a storage processor configured to receive cookies for storage from users. The system further includes a request processor which is configured to provide cookies to users in response to cookie retrieval requests from users. The personal cookie repository system may be implemented as a software application running on the server 118. The server includes a large memory forming the storage means for storing user cookies. The memory may be any sort of persistent storage device. One or more hard disk drives may be preferred for storing large amounts of user cookie data. In other embodiments, the memory may be optical disks, semiconductor memory or any other suitable storage medium. The memory may be located at a single location or distributed among two or more locations. The storage processor may be a microprocessor, controller or logic of the server, operated in conjunction with a software program, to control storage and retrieval of user cookie data. Similarly, the request processor may be any appropriate combination of hardware and software adapted to receive and interpret cookie request messages and prepare cookie response messages.

In some embodiments the personal cookie repository system implements a personal cookie repository service. The service is available to subscribers who may pay a fee for the service. The service allows authenticated user login, storage of cookies and management of cookies. The service further permits automatic download and upload of cookies during browsing.

As noted above, the user may retrieve the user's cookies for use in a browsing session at web sites such as the website 112. Following the browsing session, the user re-stores the user's cookies at a location such as the location 118 for subsequent retrieval. Retrieval of the user's cookies may be from any computing device.

In one exemplary embodiment, a user who wants to use the personal cookie repository service disclosed herein clicks on or otherwise actuates the PCR icon on the user's browser. In response, under control of the browser PCR plug-in, a login window such as the login window 200 of FIG. 2 is displayed on the display of the computing device. The user enters her username and password for authentication over a secure channel. The PCR plug-in downloads cookies from the PCR server and uploads the cookies to the server at the end of browsing.

Thus, in the embodiment of FIG. 1, the user 102 is initially using computing device 104. She actuates the PCR plug-in 114 of her browser 108 on computing device 104. The PCR plug-in 114 submits a cookie request which, in this embodiment, is an HTTP request and is communicated over the internet using TCP/IP. The request is authenticated at the cookie repository server 118. The user's previously-stored cookies are retrieved from their storage location 120 and communicated to the computing device 104 where they are made available to the browser 108. The cookies are stored in appropriate locations on the computing device 104. Thus, at a client device such as the computing device 104, client state information is retrieved from a remote location associated with the client device. The client state information includes the user's cookies, but could include other or additional information about the state of the client during the user's last browsing session. The remote location in this example is the personal cookie repository. The particular storage location at the cookie repository is specifically associated with the user so that the user's cookies, and only the user's cookies, are retrieved.

Using the cookies, the user 102 begins browsing web sites such as web site 112 using the browser 108 on the computing device 104. For each requested web page, appropriate cookies are included in the request message. The web site 112 responds by sending page information and possibly additional cookies, or updated cookies. The browser 108 stores the additional cookies and updated cookies at an appropriate location of the computing device 104. Thus, the client state information in the form of the user's cookies is used for access of network locations. Browsing continues in this manner until interrupted by the user 102.

At the end of browsing at the computing device 104, upon completion of the access of the network locations updated client state information is stored at the remote location in the personal cookie repository server 118. The updated client state information includes all current state information, including cookies received during this browsing session, cookies used and updated during this browsing session and cookies retrieved from the server 118 but not used during this browsing session. The updated client state information may include other information as well, including the user's login name and password for authenticated access to the cookie repository. The process of uploading the cookies is preferably under control of the PCR plug-in 114 operating in conjunction with the browser 108.

The computing device 104 may correspond to the office personal computer of the user 102. The browsing session ends when the user 102 leaves the office to travel home. However, during the home bound commute, the user may decide to access one or more web sites, including the web site 112. This may be done using a portable computing device 106, embodied as the cellular telephone or PDA carried by the user for wireless access to the internet. Such a portable device 106 has a limited display and data processing capability relative to the user's office personal computer. Accordingly, such a portable device 106 includes a browser 110 customized for use with a portable device. The browser 110 offers more limited capability relative to the browser 108 on the office personal computer, computing device 104. For example, the browser 110 may offer very limited graphics display capability and only a few lines of text display. However, the browser 110 operates in much the same way to send page requests to remote locations such as the web site 112 and receive responses, including cookies, from the remote locations. Similarly, the computing device 106 includes a PCR plug-in 116 for retrieving and storing the user's cookies and other client state information on the personal cookie repository server 118.

When the user 102 begins using her portable device 106 for browsing, the user 102 clicks on or otherwise actuates the PCR plug-in icon on the portable device. The PCR plug-in 116 produces a login window which may be similar to the window 200 illustrated in FIG. 2. The user 102 enters the required login information and initiates a cookie retrieval using the PCR plug-in 116. This retrieves client state information from its remote location at the personal cookie repository server 118. The server 118 responds with a response message including the stored client state information, including the user's cookies. The user 102 then uses the cookies and other client state information for access of network locations, including the web site 112.

Since the same cookie and client state information is used for this network access as was used during the previous access with the computing device 104, there is no loss or discontinuity of client states. Inconsistent cookie states, even on different devices of the same user, are eliminated.

After completion of browsing and access of network locations, the updated cookies and other client state information is stored at the remote location of the personal cookie repository server 118. Again, the stored cookies include updated cookies, new cookies and unused cookies.

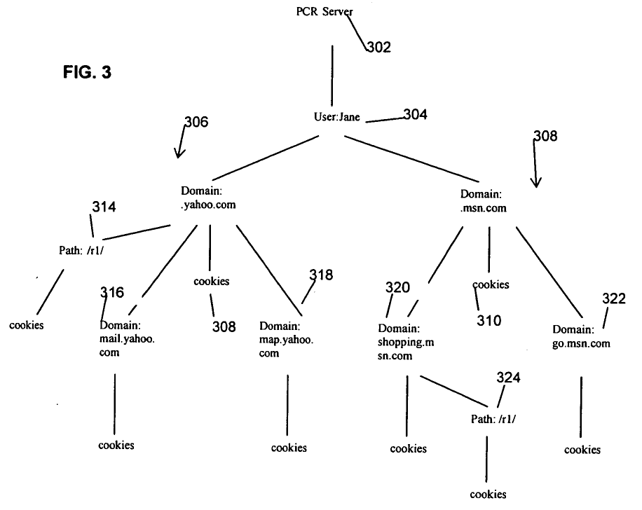

FIG. 3 illustrates one embodiment of cookie storage in a personal cookie repository server. There are many ways to design an organize cookies on a personal cookie repository server. Any suitable design may be adopted in accordance with the embodiments described herein. Some examples include using a database to store cookies, or using a hash table. FIG. 3 illustrates one embodiment, which is a tree structure design for storing cookies.

In the tree structure of the personal cookie repository server of FIG. 3, the PCR server 302 is at the root of the tree. Extending from this root are trees corresponding to all users having cookie storage accounts with the server. FIG. 3 illustrates the tree associated with user 304.

The tree for the user 304 includes branches for all the top-level domains for which the user has cookies. In the exemplary embodiment, the tree includes one branch 306 for cookies associated with top-level domain yahoo.com and a branch 308 for cookies associated with top-level domain msn.com. There are cookies 310, 312 associated with these top-level domains branches 306, 308, respectively.

Within each of the branches 306, 308 are sub-branches for sub-domains. Thus, branch 306 includes a sub-branch 314 for a path/rl/, a sub-branch 316 for domain mail.yahoo.com, and a sub branch 318 for domain map.yahoo.com. There are cookies associated with each of these domains and each of these sub-branches 314, 316, 318. Similarly, the branch 308 includes a sub-branch 320 for the domain shopping.msn.com, a sub-branch 322 for the domain go.msn.com and a sub-sub-branch 324 for the path/rl within the sub-branch 320. There are cookies associated with each of these domains and each of these sub-branches 320, 322, 324. Thus, each cookie is a leaf node in the tree and is uniquely identified by its path and domain.

The following drawing figures illustrate variations of the personal cookie repository service. Other variants are possible and can be readily produced from the provided examples. Those illustrated in the drawing and described herein are intended to be illustrative only.

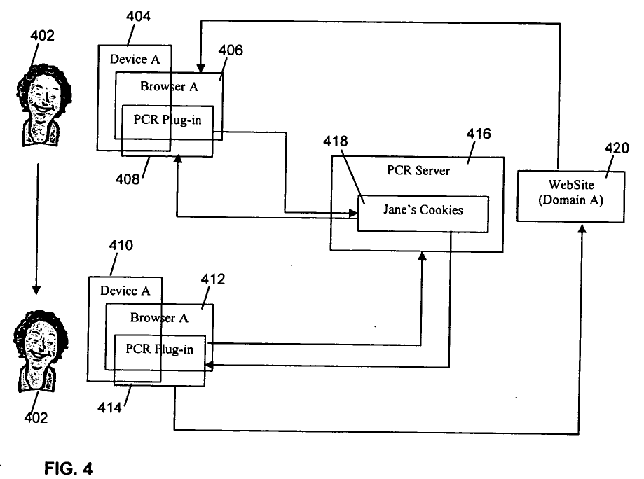

FIG. 4 is a block diagram illustrating operation of a personal cookie repository service. In this example, a user 402 owns multiple computing devices but is constrained to use only one device at a time to access a web site or other network location.

User 402 has a first computing device 404 including a browser 406 and a PCR plug-in 408. These are generally as described above in conjunction with FIG. 1. They may be customized to a particular purpose associated with the computing device 404 or its functionality. Similarly, the user 402 has a second computing device 410 including a browser 412 and PCR plug-in 410. The user 402 subscribes to a personal cookie repository service, having an account that permits authenticated login access, storage and retrieval of cookies at a personal cookie repository (PCR) server 416. The user's cookies are stored in a particular location 418 associated in some manner with the user so that the user's cookies can be uniquely stored and retrieved. Other client state information of the user, in addition to the user's cookies may be stored in the location 418 as well. The user 402 uses the browsers 406, 412 to access network locations such as web site 420.

Initially, the user 402 starts the browser 406 on the computing device 404. As described above in conjunction with FIG. 1, the user clicks the PCR icon displayed on the browser screen or otherwise activates the PCR plug-in 408. The user then signs on with the PCR server 416. Preferably, communication between the computing device 404 and the PCR server 416 is preferably through a SSL connection.

The user 402 then navigates to a target website 420. The PCR plug-in 408 in browser 406 detects this navigation and transmits a cookie request to the PCR server 416 for the cookies associated with the target website 420. The PCR server 416 communicates the user's cookies and other client state information that are associated with the target website 420. The cookies are stored on the device 404 for use by the browser 406. Browser 406 attaches cookies to a request message in the conventional manner and transmits the request message to the website 420.

The website 420 responds to the request message by preparing and transmitting a response. The website 420 attaches cookies in the response message in the conventional manner. The response message is received at the computing device 404. The cookies are detected and stored in local storage at the computing device 404.

After the user 402 finishes browsing, the user 402 closes the browser 406. As part of this process, the PCR plug-in 408 in the browser 406 uploads all cookies in the browser 406 to the PCR server 416 and signs off from the PCR server 416 before the browser 406 closes. The uploaded cookies override the user's cookies stored at location 418 in the PCR server 416.

Subsequently, the user 402 switches to device 410 for online activities. She starts the browser 412 of the device 410 and the PCR plug-in 414 signs on with the PCR server 416. Using the second device 410, the user 402 navigates to the same website 420 previously visited. The PCR plug-in 414 detects this navigation and sends a cookie request message to the PCR server 416. The PCR server 416 transmits the user's cookies to the device 410 for use by the browser 412. The browser 412 attaches cookies in a request message in the conventional manner, and sends the request to the website 420.

After the user 402 finishes her online activities, she decides to close the browser 412 on the device 410. In response, the PCR plug-in 414 uploads all cookies in browser 412 to the PCR server 416. The PCR plug-in 414 signs off from the PCR server 416 before the browser 412 exits. The uploaded cookies override the user's previously-stored cookies on the PCR server 416 that have the same domain and path.

Thus, in this example, the PCR server 416 implements an override policy for cookie storage. This policy allows the user 402 to use multiple devices to access a website at the same time, but with the restriction that only the user's most up-to-date cookies are stored in the PCR server 416. The cookies from the device used most recently always override the cookies stored on the PCR server 416.

However, there may be occasions in which the user 402 wants to preserve her cookies that are not the most up-to-date. However, the override policy illustrated above does not allow preservation of old cookies. The next example presents an alternative policy that allows the user to preserve cookies on the PCR server 416 for subsequent retrieval.

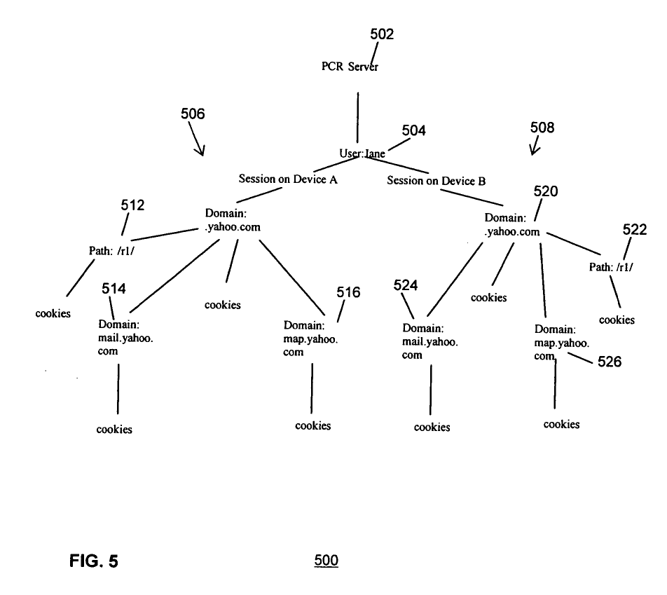

FIG. 5 illustrates an alternative embodiment of cookie storage in a personal cookie repository server. In particular, this embodiment allows a user to preserve the cookies for each of her multiple devices. When a user accesses the same web site simultaneously using two or more devices, the web site may assign multiple sessions for each accessing device. Cookies for a web session stored on a device are identified by the device's user, device, session and domain. There are many possible designs for organizing stored cookies for a web session on a device. Examples include using a database or a hash table or organizing cookies in a tree structure.

FIG. 5 illustrates one possible tree structure for organizing cookies in a personal cookie repository. In this embodiment, in addition to organizing cookies by domain, the cookies are also categorized by the name of the device, referred to as session-on-device, where the cookies are set. By organizing cookies under session-on-device, the saved session-on-device cookies are accessible to a user on any device. The cookies are not subsequently overwritten during access to the same web site by a different device.

In the embodiment of FIG. 5, the cookies are stored in a tree 500. At the root 502 of the tree is the PCR server. The trunk 504 of the tree is associated uniquely with the user to whom the cookies in the tree belong. For every subscriber to the PCR service, there is a cookie tree similar to the tree 500 illustrated in FIG. 5.

Extending from the trunk 504 of the tree are session-on-device branches 506, 508. For each session-on-device, a new branch storing new cookies is created by the PCR server. In the exemplary embodiment of FIG. 5, the tree 500 has two branches. A first branch 506 is associated with a session-on-device A, which may be the user's office personal computer. A second branch 508 is associated with a session-on-device B, which may be the user's cellular telephone.

Within each session-on-device branch 506, 508, the cookies are organized by domain, similar to the organization of the tree illustrated in FIG. 3. Thus, the branch 506 has cookies in a sub-branch 510 for a domain yahoo.com, a sub-branch 512 for a path/rl, a sub-branch 514 for a path mail.yahoo.com, and a sub-branch 516 for a path map.yahoo.com. Similarly, session-on-device branch 508 includes a similar structure for storing similar cookies accrued during a browsing session. The branch 506 has cookies in a sub-branch 520 for a domain yahoo.com, a sub-branch 522 for a path/rl, a sub-branch 524 for a path mail.yahoo.com, and a sub-branch 526 for a path map.yahoo.com.

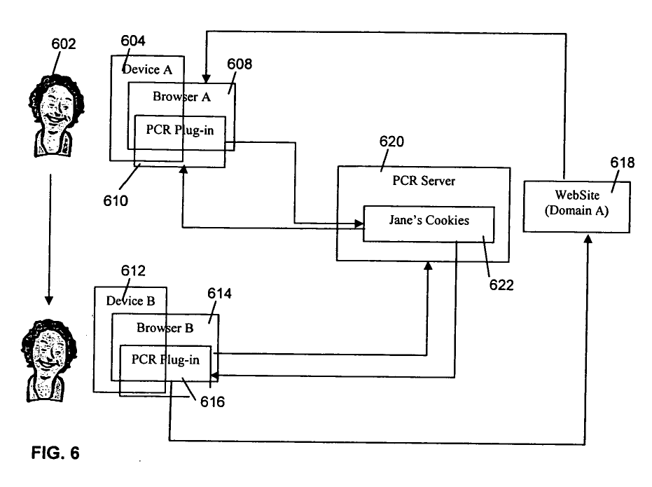

FIG. 6 is a block diagram illustrating operation of a personal cookie repository service. FIG. 6 illustrates operation of a system in which a user 602 operates a first device 604, having a browser 608 and a PCR plug-in 610, and a second device 612 having a browser 614 and a PCR plug-in 606, substantially simultaneously to access one or more web sites such as web site 618. The devices store and retrieve cookies from the PCR server 620. The cookies associated with the user 602 are stored at a location 622 on the PCR server 620.

Operation of the exemplary embodiment proceeds as follows. Initially, the user 602 starts browser 608 on device 604. The user clicks on the PCR plug-in 610 or otherwise initiates a cookie retrieval from the PCR server 620. In a typical embodiment, communication between the PCR server 620 and the PCR plug-in 610 is through a SSL connection.

Using the browser 608 on the device 604, the user navigates to the website 618. The PCR plug-in 610 detects the user's navigation and formulates a request message to the PCR server 620. The request message request cookies associated with the user 602 and the web site 618.

At the PCR server 620, the server detects that the user 602 has visited the website specified by the request message while on both her device 604 and her device 612. In response, the PCR server forms a response message which includes a group of saved session-on-devices. These include one session-on-device labeled for convenience as “session on device 604” and one session on device labeled for convenience as “session on device 612.” The user 602 is given the option to choose a session-on-device. For example, using the user interface of device 604, the user 602 selects “session on device 604.” In response, the PCR plug-in 610 in the browser 608 downloads the cookies from “session on device 604.” The browser 608 attaches cookies to the request message and sends the request message to the website 618.

At the website 618, the web site responds to the user's request message. In the conventional manner, the web site 618 attaches cookies to its response message. Upon receipt at the device 604, the cookies are saved in local storage.

At this point, the user 602 keeps browser 608 running while actuating browser 614 of the other device 612. The user 602 signs on with the Personal Cookie Repository service of the PCR server 620 from the browser 614. The user wants to navigate to the same website 618 accessed from the browser 614. The PCR plug-in 616 detects this navigation and submits a request message to the website. In response, the PCR plug-in 616 requests appropriate cookies from the PCR server 620.

The PCR server 620 is configured to detect that the user 602 has visited the web site 618 on device 604 and device 612. The PCR server 620 in response formats a response message including a group of saved session-on-devices. This group includes a session-on-device labeled for convenience “session on device 604” and a session-on-device labeled for convenience “session on device 612.” These are communicated to browser 614 of device 612. The user is given an option to select a session-on-device. In response to the selection, the PCR plug-in 616 requests cookies associated the selected session-on device.

The browser 614 attaches cookies to a request message for the web site 618. The request message is then send to the web site 618. Device 612, in conjunction with browser 614, begins to navigate the web site 618 in a separate session unique from the session of the browser 608 on device 604.

Subsequently, the user 602 finishes operation on the browser 614 and closes this browser. In this process, the PCR plug-in 616 uploads all cookies by formatting a cookies storage request to the PCR server 620. The PCR plug-in 616 then logs off the PCR server 620 before browser 614 closes. At the PCR server 620, the cookies are saved and identified as “session on device 612.” The newly saved cookies override or replace the cookies saved as “saved device 612” cookies.

The user 602 then returns to browser 608 on device 604. Subsequently, the user 602 decides to finish her online activities and closes the browser 608. The PCR plug-in 610 of the browser 608 uploads all cookies in the browser 608 to the PCR server 620 by formatting and transmitting a cookie storage message to the PCR server 620. The PCR plug-in 610 then signs off the PCR server 620 before the browser 608 closes. At the PCR server 620, the uploaded cookies are saved and identified, for example, as “session on device 604.” The newly saved cookies override the old “session on device 604” cookies.

In this manner, a preservation policy is implemented by the PCR service. A user's cookies are associated with a specific session and device and saved for subsequent use. A method for preserving cookies includes, in a first embodiment, capturing cookies on a current device, storing the captured cookies on a central storage, such as the PCR server 620, and retrieving the stored cookies from the central storage for subsequent use. Another embodiment provides a cookie preservation method for cookies shared among multiple devices. The method includes retrieving cookies from central storage such as the PCR server 620 for a first browser, such as the browser 608 and establishing an active session with a web site using the first browser. The method further includes ending the active session, updating cookies at the central storage, retrieving cookies from the central storage and reestablishing an active session using a second browser such as browser 614.

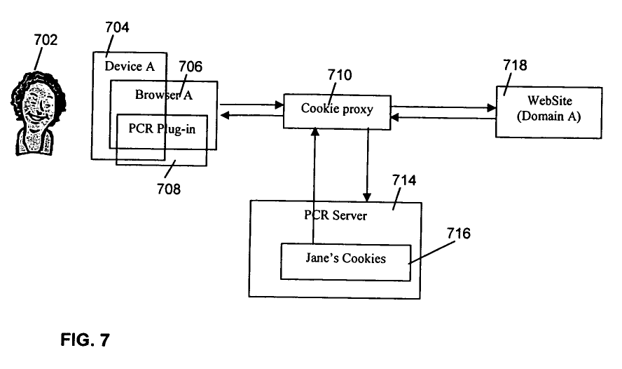

FIG. 7 is a block diagram illustrating operation of a cookie proxy system. This system allows extension of the personal cookie repository service by adding a cookie proxy so that no cookies will ever have to be set or stored on a browser of a computing device. The cookie proxy preferably works like a HTTP proxy that redirects HTTP traffic between a browser and a web site.

In one embodiment, a cookie proxy method includes receiving at a cookie proxy a request for access to a web site. The request is received from a computing device operated by a browser. The browser forms the request in HTTP to obtain a page from a remote network location. The cookie proxy is positioned between the device and its browser and the network location. In response to the request, cookies associated with the user and associated with the web site are retrieved from storage. The method further includes forming a new request using the retrieved cookies and the received request and communicating the new request to the web site.

The embodiment employing a cookie proxy system includes a computing device 704 operated by a user 702, a cookie proxy 710, a PCR server 714 and one or more web sites such as web site 718. Each of these devices is configured for network communication, which may be wireless or wireline communication or a combination thereof.

The computing device 704 is generally of the type described above in conjunction with FIG. 1. The device 704 includes a browser 706 which permits browsing of network locations such as world wide web sites. The browser 706 operates in conjunction with a personal cookie repository (PCR) plug-in 708 which may be separate application software or may be inherently a part of the browser 706 or the device 704.

The cookie proxy 710 may be any computing device capable of performing the function described herein. In particular, the cookie proxy 710 may be implemented as a server computer capable of network communications with other computing devices such as the device 704 and the PCR server 714 and for storing large amounts of data. In some embodiments, the cookie proxy 710 is implemented as computer readable program code operating in conjunction with a computing device. In one particular embodiment, the cookie proxy 710 is implemented as a software routine on the computing device which implements the PCR server 714.

The PCR server 714 is generally of the type described above in conjunction with FIG. 1. The PCR server 714 stores and manages cookies associated with users such as user 702. Each user's cookies are stored in particular locations, such as location 716 where cookies of user 702 are stored.

The web site 718 is one network location of many network locations which may be accessed by the user 702 operating the browser 706 on the computing device 704. In general, the user navigates to the web site 718 and clicks on a link associated with the web site. The browser prepares a request message in response to the user click. The request message is conveyed to the web site 718 where it is processed. If appropriate, the web site 718 prepares a response message in response to the request message. Cookie processing in the illustrated system is customized to provide the cookie proxy functionality.

For a HTTP response message from a web site to a browser, the cookie proxy in the illustrated embodiment strips cookies from the response message, saves them on the personal cookie repository, and forwards the response message with no cookies to the browser. Initially, a HTTP request is communicated from the browser 706 to the cookie proxy 710. In accordance with this embodiment, the request has no cookies attached or incorporated in the request.

The request is received at the cookie proxy 710 and, in response, a request for cookies is sent from the cookie proxy 710 to the PCR server 714. The request in one embodiment identifies the user 702 and the web site 718 associated with the request. At the PCR server 714, in response to the request for cookies, the storage location 716 where the cookies associated with the user 702 are located is accessed and a response message including the requested cookies, if any, is returned to the cookie proxy 710. If the user 702 has not previously visited the web site 718, there may be no cookies stored for that web site 718 for that user 702 at the PCR server 714.

The cookie proxy 710 receives the returned cookies and forms a new request, combining the returned cookies with the request from the user 702. The cookie proxy 710 transmits the request to the web site 718. In response, the web site 718 prepares a response message which is communicated to the cookie proxy 710. Although the cookie proxy 710 is communicating with the web site 718 on behalf of the device 704 of the user 702, the cookie proxy 710 is invisible to the web site and to the user 702 at the device 704. The response message from the web site to the cookie proxy 710 includes one or more cookies.

The cookie proxy 710 receives the response message and strips out the cookies contained in the response message. The cookie proxy 710 then prepares two messages. A first message is formatted and sent to the user 702 at the device 704. This message includes all the information from the web site 718 except the cookies. A second message is formatted and sent to the PCR server 714. This message includes the cookies from the web site 718 and identifying information for storage in the location 716 for the user's cookies.

For a HTTP request containing no cookie from a browser to a web site, the cookie proxy looks up cookies in the personal cookie repository (PCR) that match the domain of the web site. The cookie proxy attaches the located cookies to the request message and forwards it to the web site. Using the cookie proxy, a browser does not see any cookies and cookie management is completely off loaded to the cookie proxy.

In implementing the cookie proxy service illustrated herein, there are two challenges that may require modifications to a browser in order to deploy a cookie proxy. First, the cookie proxy system may not function well for web pages with client-side scripts that read and set cookies. To accommodate these web pages, a hook into browser's script engine may be required to redirect cookie read/write operations to the cookie proxy.

Further, the cookie proxy system may not function well for HTTPS messages over SSL connections. HTTPS messages are encrypted such that only the website and the browser can decrypt them. As a result, the cookies in the HTTPS message cannot be extracted and appended by the cookie proxy. There are two possible solutions to address these issues.

A first solution is to split an end-to-end SSL connection into two SSL connections—a browser-proxy SSL connection and a proxy-website SSL connection. For a HTTPS response message received from proxy-website SSL connection, the cookie proxy decrypts the message, strips the cookies from the message, and re-encrypts the message for the browser-proxy SSL connection. For a HTTPS request messages received from browser-proxy SSL connection, the cookie proxy decrypts the message, attaches cookies to the message, and re-encrypts the message for the browser-proxy SSL connection.

A second solution is for the client browser to share its SSL client private key and SSL server public key with the cookie proxy via a secure unicast connection, so that the cookie proxy can modify HTTPS messages without having to split the underlying SSL connection. Note that both solutions require breaking the end-to-end security model of SSL connections, so there are certain security risks associated with them. As a result, they should be done only when the browser and the cookie proxy are within the same trusted security administrative domain.

From the foregoing, it can be seen that the presently disclosed embodiments provide a personal cookie repository (PCR) service that maintains up-to-date cookies for the user regardless of which device the user uses to access websites. The PCR service also eliminates the need to transfer cookie state between browsers. T\he PCR service automatically synchronizes the state of cookies between any user device and the cookie repository server. The utility of the service is extended by disclosing a preservation policy by which a user's cookies are preserved for subsequent use and a cookie proxy system to eliminate storage of any cookies at the user's computing device.

While a particular embodiment of the present invention has been shown and described, modifications may be made. For example, while the embodiments herein are described in connection with the internet in general and the World Wide Web in particular, it is to be recognized that these embodiments may be readily extended to other network environments such as intranets, wireless networks, satellite networks and other network systems as well. It is therefore intended in the appended claims to cover such changes and modifications which follow in the true spirit and scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. A browser plug-in comprising:
icon code for displaying an icon on a browser screen of a computing device;
login screen code for displaying a login screen on the browser and receiving login information from a user of the computing device; and
access code for accessing cookies associated with the user over a network at a personal cookie repository network location.

12. The browser plug-in of claim 111 wherein the access code comprises:
upload code for storing cookies received during network access with the browser, the cookies being stored in association with identification for the user at the personal cookie repository network location; and
download code for retrieving the stored cookies associated with the user at the personal cookie repository network location.

13. The browser plug-in of claim 11 further comprising:
authentication code for initiating authenticated login access to the personal cookie repository network location is response to the received login information for the user.

14. The browser plug-in of claim 11 further comprising:
navigation monitoring code for detecting a target network location selected by the browser and for cooperating with the access code for accessing cookies associated with the target network location.

15. (canceled)

16. (canceled)

17. (canceled)

18. (canceled)

19. (canceled)

20. (canceled)

21. (canceled)

22. (canceled)
